(19) United States
(12) Patent Application Publication
(10) Pub. No.: US 2019/0235339 A1
(43) Pub. Date: Aug. 1, 2019

(54) ELECTROCHROMIC DEVICE STRUCTURES WITH CONDUCTIVE NANOPARTICLES

(71) Applicant: POLYCEED INC., Tucson, AZ (US)

(72) Inventors: John P. CRONIN, Tucson, AZ (US); Anoop AGRAWAL, Tucson, AZ (US); Lori ADAMS, Tucson, AZ (US)

(73) Assignee: POLYCEED INC., Tucson, AZ (US)

(21) Appl. No.: 16/259,195

(22) Filed: Jan. 28, 2019

Related U.S. Application Data
(60) Provisional application No. 62/623,249, filed on Jan. 29, 2018.

(51) Int. Cl. G02F 1/1503; G02F 1/1523; G02F 1/153

(52) U.S. Cl. CPC G02F 1/1503; G02F 1/1533; G02F 1/1525

(57) ABSTRACT

An electrochromic device comprising redox layers which contain conductive nanoparticles. These nanoparticles are made from metals, metallic alloys, coated metals and carbon. An electrochromic device comprising two redox layers wherein both redox layers contain metallic nanowires and the composition of the nanowires in the two layers is different. Further use of carbon salts as conductive nanoparticles in electrochromic devices is disclosed.

### CROSS-REFERENCE TO RELATED APPLICATIONS

This application claims priority benefit of U.S. provisional application Ser. No. 62/623,249 filed on Jan. 29, 2018.

### FIELD OF THE INVENTION

The present invention relates to electrochromic (EC) glass and devices, having ability to control the color and transparency of the glass, and specifically to electrochromic glass devices having conductive nanoparticles

### BACKGROUND

Electrochromic (EC) devices are based on the electrochromic characteristic of materials. When applied or formed using glass, or other substrates, these devices change color, opacity, and/or transparency with the application of a voltage. Such devices are referred to as “smart glass” or “smart windows” as the characteristics of the glass, or other substrate, is changed by electronic switching. Used in buildings, these smart windows may provide shade, energy savings, privacy, partitions and so forth. The user may control the heat or light that passes through the glass using electronic switching, rather than shade, blinds or drapes. There is a great interest in the use of EC devices for energy saving; however, EC devices may be used for variable transmission windows, automotive mirrors for controlling reflectivity and displays.

Used in construction of buildings and in elements in transportation, these windows result in energy efficient building envelopes and increased comfort by regulating the solar energy penetration through the windows. For building glazing applications, wide acceptance will mean that the smart windows are available at an acceptable cost and that smart windows operate on low-power. Current EC designs incur are costly due to the materials and the processes used to make them.

EC devices with conductive nanoparticles in electrode layers were taught in U.S. Pat. No. 8,593,714. This patent discloses the use of conductive nanoparticles, particularly the use of percolated network of conductive nanofibers (or nanotubes) in EC electrode compositions so as to enhance the redox activity of the EC materials present in these layers. Amongst, the various type of conductive nanoparticles, use of conductive carbon nanotubes (CNT), metal, metal carbide and metal nitride nanowires has been taught. EC layers are also taught where in an electrolytic matrix (or ion conductive matrix) nanoparticles of inorganic oxides along with the conductive nanoparticles are employed. In the current disclosure use of carbon salts as conductive nanoparticles is taught in the above devices.

Published PCT application WO/2018/009645 also discloses specific type of EC devices where inorganic EC layers are combined with layers containing both EC materials and conductive nanoparticle networks (such as CNTs) in an EC device. In the current disclosure use of carbon salts as conductive nanoparticles is taught in the above devices.

Published PCT applications WO2017/137396; WO2017/153403 and WO2017/153406 provide details of electrochromic devices employing EC layers formed from electrolytic matrix containing nanoparticles of inorganic oxides along with the conductive metallic nanowires. These applications list certain compositional details of the formulations to make EC layers and construction of the devices (e.g., layer thicknesses) where the two electrodes (i.e., the cathodic and the anodic) both comprise of metallic nanowires (particularly silver). However, no details of the fabricated EC devices, their optical properties, electrical properties or their electrochemical or durability performance are provided. In the current disclosure improvements to the above devices are taught by modifying the metallic nanowires while also suggesting suitable powering protocols to enhance their durability.

In practical devices one has to use materials with high redox stability, i.e., sufficient potential should be applied to reversibly reduce or oxidize the EC materials to provide coloration without damaging (i.e. reducing or oxidizing) any of the other components which will result in irreversibility and interfere with the intended function of the device. Further, it is important to ensure that the nanoparticles are well dispersed, particularly the conductive nanoparticles. This ensures that these particles provide adequate conductivity throughout the layer with least optical distortion (color or haze) and also results in lower cost since the amount of such particles used is low for a well dispersed system. In addition, when one uses the conductive particles (including nanowires or nanotubes or nano-sheets such as graphene) one has to ensure that these materials have sufficient redox stability in the system. The purpose of this application is to address these issues about obtaining superior dispersion and proper use of conductive nanoparticles so that the performance and the durability of the EC devices is not compromised due to the low redox stability of the conductive nanoparticles.

### SUMMARY OF THE INVENTION

The present disclosure includes an electrochromic device comprising two redox layers in which a first redox layer contains metallic nanowires and a second redox layer contains nanoparticles of carbon salt, and further the first redox layer with the metallic nanowires colors cathodically. In some aspects, the cations of carbon salt are selected from organic ions and alkali metal ions. In some aspects, the nanowires and the nanoparticles are immobilized in the layers by chemical attachment to a polymer therein. In some aspects, an agent is added to prevent thermal or chemical oxidation of the metallic nanowires. In some aspects, the bleach potential of the device does not exceed 0.5V, and during bleach, the redox layer with the metallic nanowires is anodic.

In some aspects, the present disclosure provides an electrochromic device that includes salts of carbon and at least one redox layer. In some aspects, the salts of carbon are added in the redox layer. In some aspects, the carbon is in the form of nanotubes and graphene sheets. In some aspects, the cations of carbon salt are selected from organic ions and alkali metal ions. In some aspects, the carbon salt particles are immobilized by reacting with a polymer present in the redox layer. In some aspects, one of the two redox layers comprise metallic nanowires and during coloration of the device the said layer colors cathodically and when the device is bleached the said layer is anodic and the bleach potential does not exceed 0.5V. In some aspects, an agent to prevent oxidation of the metallic wires is included.

In some aspects, the present disclosure provides an electrochromic device having two redox layers wherein a first redox layer contains metallic nanowires and a second redox layer does not contain metallic nanowires, and further the redox layer with the metallic nanowires colors cathodically. In some aspects, the electrochromic device can be bleached at a potential which is reverse in polarity to the coloring potential and is less than 0.5V. In some aspects, the second redox layer has conductive particles of carbon salt. In some aspects, the cations of carbon salt are selected from organic ions and alkali metal ions. In some aspects, an agent is added to the said layer to prevent oxidation of the metallic nanowires.

In some aspects, the present disclosure provides an electrochromic device comprising two redox layers wherein both of these redox layers contains metallic nanowires and further the composition of the nanowires in the two layers is different. In some aspects, at least one of the layers further contains carbon nanoparticles. In some aspects, the carbon nanoparticles are carbon salts. In some aspects, the layers contain agents to prevent chemical or thermal oxidation of the metallic nanowires. In some aspects, cations of carbon salt are selected from organic ions and alkali metal ions.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 illustrates a schematic representation of carbon salt where the anions are carbon nanotubes.

FIG. 2 illustrates schematics of electrochromic (EC) devices according to embodiments of the present invention.

### DETAILED DESCRIPTION

An object of this invention is to provide durable electrochromic (EC) devices for glazing and other applications, have low optical haze and can be produced at an attractive cost.

As discussed in the earlier section some of the EC device constructions employ conductive nanoparticles to provide electrical conductivity in some of the redox layers. A percolated network of metal nanowires can achieve this purpose. Some of the common and less expensive metals used for nanowires are silver, copper, tungsten and nickel, which have oxidation potentials of −0.8V, −0.34V, +0.12V and +0.25V respectively on the standard hydrogen electrode. The more noble metals such as gold (oxidation potential of −1.5V) is too expensive for most applications. The above shows that of the above listed lower-cost metals silver is most difficult to oxidize electrochemically, but still relatively speaking it has a low oxidation potential. Thus, in those EC devices where there is a large asymmetry in coloration and bleach potentials, one may use metallic nanowires on the cathodic side (cathodic during coloration) so that the metal nanowires present in the redox layer is not oxidized. The common metals mentioned above could also chemically oxidize in the layers they are incorporated during use or even when such layers are being processed (e.g., under ambient conditions and or heat). Thus, it is desirable to add to these layers antioxidants and thermal stabilizers that do not interfere with any of the redox (or electrochromic) activity but still provide the protection against oxidation. For example, benzotriazoles and its derivatives may be used for this purpose which are also used as UV stabilizers.

The asymmetry about the potentials (i.e., coloration potential being different from the bleach potential) arises because when the voltage is reversed for bleaching then the cathodic electrode (during coloration) now becomes the anode and hence the chances of the metal to oxidize are high. Thus, there are two requirements for durable EC devices when silver nanowires are used, first, that they are used only in the cathodic electrode (for coloration) since the coloration potential (i.e., the difference between the two opposing electrodes is usually about 0.8V or greater). When these devices are bleached by reversing the potential, i.e., the layer with the metallic wires will become anodic and will have a higher propensity for the metal to oxidize irreversibly. Thus, under these conditions, these devices must bleach at low potentials, typically less than 0.5V and in another embodiment at or less than 0.3 V or in another embodiment at 0V (such as by electrically shorting the two opposing electrodes). The latter will ensure that the silver nanowires in the cathodic layer (during coloration) do not oxidize upon bleaching. This window of bleach potential will be even smaller when other of the above named common metals are used. Generally, asymmetric coloring and bleaching conditions are used for most metallic nanowires unless they are made out of gold or their surfaces passivated as discussed below.

In one embodiment the EC device only use metal nanowires in a cathodic layer (cathodic when coloring) and do not use metal nanowires in the opposing anodic layer. In yet another embodiment, the cathodic layer (when coloring) has silver nanowires and the anodic layer has nanowires made out of different composition such as a different metal; metal alloy; silver nanowires coated with another material (such as gold, carbon, conductive metal oxide, metal nitride or metal carbide); and use of carbon nanotubes and sheets (see below) which are more difficult to electrochemically oxidize as compared to silver. Examples of conductive metal oxides are tin doped indium oxide (ITO) and antimony doped tin oxide (ATO). In another embodiment nanowires (or nanotubes) which are more difficult to electrochemically oxidize than silver may be used in both anodic and cathodic layers of the EC device, such as those made out of carbon as discussed below.

Conductive carbon nanoparticles include carbon nanotubes (CNT), graphene and mixture of these. This is described in U.S. Pat. No. 8,593,714, Published PCT application WO2018/009645 and in a non-published PCT application PCT/US17/68813 (filed on Dec. 28, 2017) and Non-provisional U.S. patent Ser. No. 16/231,909 filed on Dec. 24, 2018. The entire contents of each of these patents and applications including materials, compositional and geometric details of layers, device structures and their working principles are included herein by reference.

An advantage of carbon materials is their high electrochemical stability range. Higher electrochemical stability in the context of a given device containing given redox materials means that the conductive materials do not undergo oxidation or reduction in the electrochemical range of device activity (or the potentials it is powered to). These may also be mixed with metallic nanowires, but then one has to take into consideration the redox issues described above.

One challenge in using carbon-based materials is their difficulty in dispersing in proper matrices required in the electrochromic devices. This occurs because of a large negative charge that binds clusters of CNTs and graphene sheets together and they are difficult to split apart. Certain solvents with suitable solubility parameters may be used to overcome these forces to a limited extent but then these solvents may not be compatible with the other electrolytic ingredients during processing, or they may be difficult to process due to their high boiling points and in some cases the particles may even agglomerate when the coatings are being dried as these solvents leave the coatings.

For electrochromic devices, instead of using carbon nanoparticles as discussed above, salts of these nanoparticles are used. These salts are easier to disperse in matrices used for electrolytes as these electrolytes also have dissolved salts of alkali ions and other materials. Exemplary preparation of salts of carbon nanoparticles are discussed in the following references Tune D. et al, Aligned carbon nanotube thin films from liquid crystal polyelectrolyte inks, ACS Applied Material Interfaces, (2015) vol 7 p-25857-25864 and Penicaud, et al Spontaneous dissolution of a single—wall carbon nanotube salt, J. American Chemical Society, (2005) vol 127, p-8-9; A. J. Clancy, J. Melbourne and M. S. P. Shaffer, A one-step route to solubilised, purified or functionalised single-walled carbon nanotubes J. Mater. Chem. A, 2015, 3, p-16708-16715. The entire contents of each of these publications including materials and their working principles are included herein by reference.

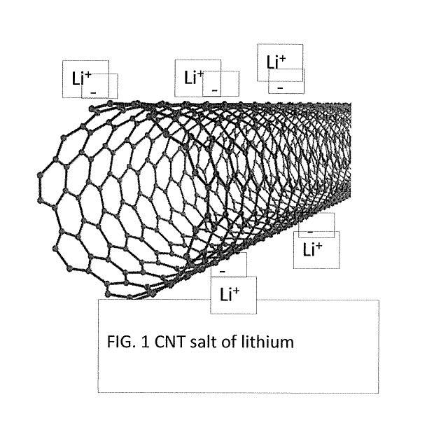

These salts are typically prepared by reacting the carbon based nanoparticles (such as CNT and graphenes) by alkali metals (such as Li, Na and K). The compositions of these salts may be chemically expressed as M+Cₓ⁻. Where M is an alkali atom and C is carbon (or carbon-based nanoparticles), and X in one embodiment is in the range of 5-500, and in another embodiment in the range of about 10-200. A schematic of a lithium salt of the CNT is shown in FIG. 1. These salts are easier to disperse in formulating EC electrodes where the conductive particles are dispersed in an electrolytic matrix containing several other additives. These additives include other alkali metal salts (e.g., of lithium) and salts of large cations (e.g., ionic liquids, EC dyes, etc). One may also replace some or all of the alkali ions in the carbon salts with larger organic cations such as quartenary ammonium cations, such as pyridinium, pyrrolidinium, pyridazinium, pyrimidinium, pyrazinium, imidazolium, pyrazolium, thiazolium, oxazolium, and triazolium. These ions may have various substitutions or substituents, such as H, F, phenyl and alkyl groups with 1 to 15 carbon atoms. EC salts such as materials containing bipyridinium ions may also be used (including those that may be coupled or bridged to other EC materials such as ferrocene-viologen, phenazine-viologen, phenothiazine-viologen, etc). Some other additives in the electrolytic matrices are polymers, monomers, catalysts and reactive agents to polymerize the monomers, plasticizers (ionic and non-ionic), UV stabilizers, viscosity modifiers (e.g., fumed silica), spacers to control thickness, colorants, etc.

In addition to making salts of carbon nanoparticles, the carbon nanoparticle salts may also be surface functionalized, where typically groups such as amines hydroxyls, vinyl, epoxy, etc., are covalently attached. In general, these modifications to particles usually occur towards the open end of the tube or the edges of the graphene sheets where the carbon atoms are more reactive as the carbon network forming these sheets and tubes is interrupted. These modifications can also help with dispersion, but importantly these may be reacted and bonded to the redox materials present in the layer or/and be tied to the polymers in that layer by bonding to them covalently and immobilizing these particles from being transported.

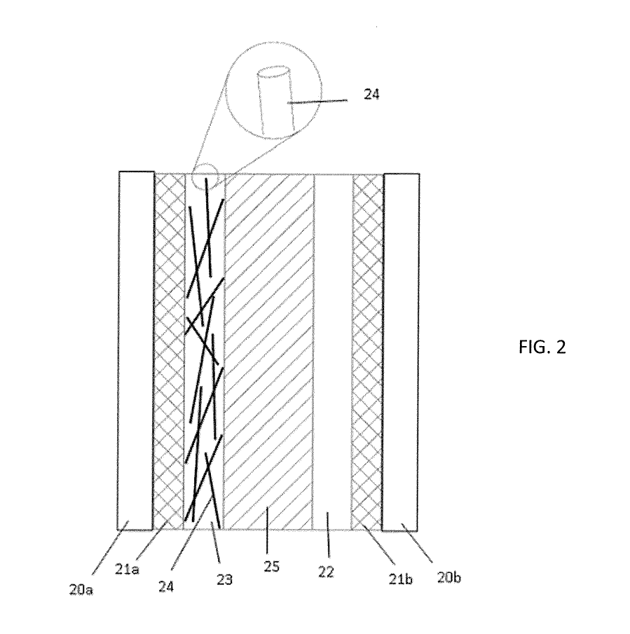

FIG. 2 shows schematics of n EC device panel for use in a window incorporating current embodiments. Substrates 20a and 20b are transparent substrates which may be rigid or flexible and made out of glass (e.g., soda lime glass) or clear polymers. These are respectively coated with transparent conductors (TCs) 21a and 21b forming the two current carrying conductors for the two opposing electrodes. Typical TCs are indium tin oxide, fluorine doped tin oxide, aluminum-zinc oxide, etc. Their surface resistivity depending on the application and device size is in the range of about 1 to 100 ohms/square. Layer 25 is an electrolyte layer which separates the two opposing redox layers 22 and 23. Both or one of the redox layers have electrochromic properties, one is anodic (i.e., colors when this layer is oxidized) and the other is cathodic (i.e., colors when this layer is reduced). Conductive nanoparticles are shown in the redox layer 23 as 24 in the shape of nanofibers or nanotubes which are percolated. In the context of this invention if these conductive nanoparticles are metallic then these are incorporated in the cathodic layer (cathodic for coloration). In another embodiment the conductive nanoparticles (nanotubes and graphene sheets) are carbon salts and yet in another embodiment a mixture of carbon salts and metals. The cathodic EC material in one embodiment are nanoparticles of inorganic oxides such as those containing tungsten oxide, in another embodiment this layer may have cathodic dyes which include viologens, and in another embodiment cathodic conductive polymers. If the conductive particles provide sufficient conductivity then the transparent conductor may be eliminated, but in order to seal the device at the perimeter and provide current edge (or perimeter) conductors will be needed, e.g., see the embodiment with perimeter conductors in FIG. 6 of the PCT patent application PCT/US17/68813 (filed on Dec. 28, 2017). Not shown in FIG. 2 of the current disclosure is the presence of a selective ion conducting layer (SICL) which may be optionally inserted between layer 25 and 22 and allows small ions (e.g. lithium ions) to penetrate but not the larger ions. This layer can improve the memory of the device, i.e., maintaining the desired optical state after switching and the electrical power is disconnected. This layer may also assist in improving the UV stability by preventing direct contact between the electrolyte layer 25 to come in contact with layer 22 if the latter has semi-conductive properties.

In one exemplary device, layer 22 contains cathodically coloring inorganic coating of tungsten oxide or an inorganic coating of mixed metal oxides including tungsten oxide as one of the oxides, SICL layer if used is a fluorine containing inorganic material such as fluorides of aluminum and lithium or an ionic polymer (e.g., lithium salt of polystyrene sulfonate), and the layer 23 containing the conductive nanoparticles has anodic properties (during coloration).

In another example of the EC device shown in FIG. 2, layer 23 is cathodic and has conductive nanoparticles dispersed in an electrolytic matrix along with a cathodic EC material. Examples of opposing anodic layers (layer 22) which do not have conductive particles are coatings (monolith) of inorganic oxides such as nickel oxide, iridium oxide, etc., or these are conductive polymers such as polythiophene. In another embodiment both redox layers (i.e., layers 22 and 23) may also have conductive particles along with particles of inorganic EC materials or EC dyes dispersed in an electrolytic matrix. In some cases, same or different bridged dyes may be used in both of the opposing redox layers. The bridged dyes have both anodic and also cathodic characters (e.g., ferrocene-viologen, phenazine-viologen, phenothiazine-viologen, phenazine-phenothiazinetriarylamine-phenothiazine, anthraquinone-viologen, etc.) thus they are usable in both layers. Such bridged dyes are preferred in many devices due to their high UV and electrochemical stability, but when coloring then on the cathodic side of the device only cathodic part of the dye is reduced, and on the anodic side only the anodic part of the dye is oxidized. In case if the same dye material is used in both layers, then depending upon the type of conductive nanoparticles used, the device will only be colored by applying cathodic voltages to the layer containing metallic nanoparticles. If conductive nanoparticles present in layer 23 were made out of silver then this layer is cathodic during coloration. If layer 22 also has conductive nanoparticles, then these particles must be made out of materials which are more difficult to oxidize electrochemically as compared to silver as discussed earlier. However, both redox layers may have carbon salt based conductive nanoparticles.

In one embodiment, the redox materials may also be covalently bonded to the conductive particles. In a second embodiment the conductive nanoparticles are bonded to the polymeric material in the layer so that the particles are immobilized from being transported within the same layer or into an adjacent layer. In a third embodiment they have limited mobility without being covalently tied in the layer (due to the high viscosity or solid state of polymeric matrix during the conditions of use (such as temperature range).

The mobility of the conductive particles during the use of the EC device is also restricted within the redox layer so that they do not lose their contact with the underlying conductive layer (e.g., transparent conductive layer), or the particles accumulate in the redox layer non-uniformly or so that they lose contact with most of the EC (or redox) materials in that layer. All these scenarios can result in a loss or change in performance of the EC device which is not desirable. These particles may be constrained in their layers physically, i.e., having the viscosity of the layers high enough during the temperature range of operation that they are physically trapped by the polymer present in the layer. They may also be functionalized on their surfaces with groups such as hydroxyl, epoxy, vinyl, amine, etc., so that they can be chemically linked to the polymeric matrix of the layer they are in. Making the electrolyte layer (layer 25) of high viscosity (or solid with higher hardness), crosslinked or partially crystallizable (with crystal sizes smaller than 400 nm in one embodiment and less than 100 nm in another embodiment) will also impede or prohibit the transport of the conductive nanoparticles into this layer from an adjacent layer containing such particles.

The electrolyte layer 25 may be a solid or a liquid. This layer may be a polymeric ion-conductive layer containing a plasticizer that is able to dissolve the various components such as lithium salts, UV stabilizers, and is compatible with the matrix polymers. The plasticizer may comprise both polar liquids (typically with a boiling point in excess of 200° C.) and ionic liquids (with a melting point of 25° C. or lower). Matrix polymers solidify the matrix and may be thermoplastics or thermosets—some examples of thermosets are epoxies, urethanes and acrylics. Some of the exemplary anions for the salts, ionic liquids and the dye salts are (CF₃SO₃⁻), imide (N(CF₃SO₂)₂⁻), beti ((C₂F₆SO₂)₂N⁻), methide (CF₃SO₂)₃O⁻), tetraflouroborate (BF₄⁻), hexaflourophosphate (PF₆—), and bis(fluorosulfonyl)imide (N(FSO₂)₂⁻). Some of the exemplary cations for the ionic liquids are quartenary ammonium cations, such as pyridinium, pyrrolidinium, pyridazinium, pyrimidinium, pyrazinium, imidazolium, pyrazolium, thiazolium, oxazolium, and triazolium. These cations may have various substitutions or substituents, such as H, F, phenyl and alkyl groups with 1 to 15 carbon atoms. Rings may even be bridged. For ionic liquids imide, beti bis(fluorosulfonyl)imide and methide anions may perform better in some applications as these are hydrobhobic. An example of an ionic liquid (IL) is 1-butyl-3-methyl pyrrolidinium bis(trifluoromethanesulfonyl)imide (BMP). Some examples of non-ionic high boiling point plasticizers are: propylene carbonate; Y⁻-butyrolactone; tetraglyme; sulfolane; monofluoroethylene carbonate; difluoroethylene carbonate; Triethylene glycol di-(2-ethylhexanoate); I-Phenoxy 2-propanol; 2-Ethyl-hexane-1,3-diol. Mixtures of several of these plasticizers may be used.

Some examples of the polymers that may be employed in the electrolytes (or redox layers having nanoparticles with an electrolytic component) are poly methylmethacrylate, polyvinyl butyral, aliphatic polyurethanes, fluorinated polymers and copolymers such as copolymers of polyvinylidene fluoride and mixtures of these. These polymers may be completely amorphous or semicrystalline thermoplastics. Other additives in the electrolyte include UV stabilizers, tinting dyes and rheology modifiers (such as fumed silica).

In addition to using UV stable dyes and inorganic EC layers, UV stability of the EC devices is further improved by using UV stabilizers incorporated in various layers of the EC devices or even blocking substantial UV from entering into the device. These may be incorporated in the electrolyte and the dye containing layers or any other organic layers including polymeric substrates if used. In addition, UV blocking into the EC devices may also be provided by using laminated substrates where the sandwiched polymeric sheet material or one or more coatings on these substrates contains appropriate type and concentration of UV stabilizers. Different types of UV stabilizers may be mixed, each having different mechanisms to thwart the UV threat and each with activity in different wavelength ranges, such as those covering about 280 to 400 nm. UV absorbers include benzotriazoles, triazines, benzophenone, cyanoacrylates salicyclates and others (e.g., Tinuvin® 1130 is a benzotriazole and Tinuvin® 400 is a triazine from BASF (Germany)). Hindered amine light stabilizers (HALS) may be used along with the above absorbers (e.g., BASF's Tinuvin® 123 and Tinuvin® 292), wherein generally, specific HALs are much more effective in preventing degradation when such HALS have substitution on the hindered nitrogen by hydrogen or alkyl. U.S. Pat. No. 7,595,011 provides additional details on specific type of materials, combinations and their use, and is incorporated herein by reference in its entirety. A system may also use nitroxyls, hydroxylamines and hydroxylamine salts (see U.S. Pat. No. 7,718,096, which is incorporated herein by reference in its entirety) along with other UV absorbers. Any of the components when used in redox layers and the electrolyte used must also be stable in the electrochemical range of interest, which will depend on the redox potentials needed for the reversible EC activity. The presence of these HALS also extends the usable lifetime of the UV absorbers. In those layers where EC dyes are present, usually the concentration by molarity of each of the UV absorbers/stabilizers (including HALS) is about 0.1 to 20 times that of the EC dye being used, and in some embodiments these are in the range that is between 1 to 10 times of that of EC dye used.

When forming layers 22 and 23 where both use electrolytic compositions with bridged dyes and conductive nanoparticles, similar compositions may be used for both of these layers.

Typically in layers 25 and in layers 22 and/or 23 when formed using electrolytic compositions, the proportion by weight of the polymer is in the range of about 3% to 70% as compared to the plasticizer. The lower range is for electrolytes (for layer 25) which are viscous fluids or are solids with poor strength, whereas polymer content is about 25% or more electrolytes that are mechanically stronger and suitable for lamination purposes and suitable for all three layers. Based on the plasticizer content, the molarity of EC dyes (or redox materials) when used is generally in the range of about 0.01 to 0.5 molar, and the salt concentration is in the range of about 0.01 to 1 molar. The concentration of the inorganic EC oxide nanoparticles if used in layers 22 or 23 instead of the dyes is in the range of 5 volume % or less of the total composition of the layer. The concentration of the conductive nanoparticles is typically about 0.0005% to 5% by weight, and in other embodiments it is about 0.002% to 1% by weight of the total composition. The concentration by weight of the UV stabilizer is generally in the range of about 0.2 to 10% of the total formulation and in another embodiment 0.5 to 6%. The nanoparticles in one embodiment should have at least one dimension lower than 100 nm, but typically for superior optical requirements in window devices in another embodiment it should be below 20 nm. The size of the inorganic EC oxides when used should be in the range of about 2 to 20 nm, and also the average diameter of the conductive nanoparticle fibers (or tubes) should be less than about 20 nm and larger than 0.7 nm, and generally for carbon when single or double wall type of particles are used to lower optical absorption their average diameter is in the range of about 0.7 to 2 nm. The aspect ratio of fibers or tubes should be greater than 100 and in another embodiment in the range of about 100 to 10,000. The redox layers containing the conductive nanoparticles with redox dyes or redox particles may have their thickness in one embodiment from about 1 to 200 μm and in another embodiment from about 2 to 100 μm and yet in another embodiment about 5 to 25 μm. As a comparison, when a device uses a redox layer with a monolithic coating of an inorganic oxide such as tungsten oxide (i.e., not the nanoparticles of inorganic oxide in an electrolytic matrix with conductive particles), their layer thickness is smaller and is in the range of about 100 nm to 1 μm in one embodiment and from 200 to 700 nm in another embodiment. Further in another embodiment the redox layers containing conductive particles and dyes and/or particles of redox materials have specific gravity in the range of 1.1 to 2 and yet in another embodiment this range is from 1 to 2.5. The specific gravity of monolith inorganic oxide coatings (which may be porous) with redox properties is between 3 and 7 and in another embodiment between 2.5 and 6.

The desired optical properties of the window devices (for use in architectural and automotive applications) can be defined by transparency and haze. The optical haze of the EC panels to be used in the window systems as measured by ASTMD1003 should be less than about 2%. The visible transmission of the panel in the clear state should be in the range of about 40 to 75% and in the dark state is about 1 to 10% and in some embodiments it may be lower than 1%. These EC panels can then be integrated with Low-e coated glass panels in an IGU configuration for installation in buildings. Curved EC panels may also be made for automotive use, or these can be made using rigid glass or more flexible polymeric substrates (e.g., polycarbonate, polyethylene terephthalate, polyethylene naphthalate and fluorinated polymers such as polyvinylidine fluoride). When these EC panels are made using flexible substrates they may be further incorporated between two rigid substrates (e.g., made out of glass) of similar curvature, size and shape by using two laminating polymeric sheets (on either side of the EC panel, e.g., polyvinyl butyral, polyurethane, etc.). In the latter case, one could protect the devices from UV in a way so that substantial UV is attenuated prior to entering the device (attenuating 99% or higher of the solar radiation in the range of 280 to 400 nm). One method is to have UV attenuating agents in the flexible polymeric substrates which form the EC devices and/or the flexible laminating sheets used for lamination.

The layers 22 and 23 may be printed or formed as coatings from liquid solutions or liquid formulations where after deposition a solvent present in the formulation is removed and/or a liquid monomer is polymerized to leave a solid coating. These coatings may be formed on substrates 20a and 20b which are already pre-coated first with the transparent conductors 21a and 21b respectively. These coated substrates may then be laminated using elevated temperature and pressure using electrolyte 25. Alternatively, these two substrates are assembled together by a perimeter adhesive to form a cavity with the coatings facing inside, which is then filled (through a hole in the substrate or in the perimeter adhesive) by a liquid electrolytic formulation and then may be optionally polymerized into solid by cooling or further polymerization. The holes where the liquid electrolytic formulation was introduced are plugged after the introduction of the electrolytic formulation. The layers 22 and 23 may also be formed by depositing them as coatings on a preformed electrolyte sheet 25 (e.g., extruded or cast) and then laminating the tri-layered sheet (comprising 22, 25 and 23) between the conductive substrates. One may also extrude this tri-layer sheet with all the three layers (co-extruded) and then laminate. The laminated devices either during the lamination or after the lamination are sealed at the perimeter to exclude moisture and air ingress.

Monolithic redox layers (that is layers not containing discrete conductive particles and redox particles or dyes) such as those contemplate for some devices in Layer 22 may be deposited by several methods including physical vapor deposition (e.g., sputtering, evaporation), liquid coating (solgel process using meniscus, dip or spray coating, or using a curtain coating process) or a chemical vapor deposition process.

The discussion, description, examples and embodiments presented within this disclosure are provided for clarity and understanding. A variety of materials and configurations are presented, but there are a variety of methods, configurations and materials that may be used to produce the same results. While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. An electrochromic device comprising two redox layers wherein first of these redox layers contains metallic nanowires and the second of these redox layers contains nanoparticles of carbon salt, and further the redox layer with the metallic nanowires colors cathodically.

2. The electrochromic device of claim 1, wherein the cations of carbon salt are selected from organic ions and alkali metal ions.

3. The electrochromic device of claim 1, wherein the said nanowires and the nanoparticles are immobilized in the layers by chemically attaching them to a polymer contained in the said layer.

4. The electrochromic device of claim 1, wherein an agent is added to prevent thermal or chemical oxidation of the metallic nanowires.

5. The electrochromic device of claim 1, wherein, the bleach potential of the device does not exceed 0.5V, and during bleach the redox layer with the metallic nanowires is anodic.

6. An electrochromic device comprising salts of carbon and at least one redox layer.

7. The electrochromic device of claim 6, wherein the salts of carbon are in the redox layer.

8. The electrochromic device of claim 6, wherein the carbon is in the form of nanotubes and graphene sheets.

9. The electrochromic device of claim 7, wherein cations of carbon salt are selected from organic ions and alkali metal ions.

10. The electrochromic device of claim 6, wherein particles of the carbon salt are immobilized by reacting with a polymer present in the redox layer.

11. The electrochromic device of claim 6, wherein one of the two redox layers comprises metallic nanowires and is configured such that, during coloration of the device, the layer colors cathodically, and when the device is bleached, the layer is anodic and the bleach potential does not exceed 0.5V.

12. The electrochromic device of claim 11, wherein the layer contains an agent to prevent oxidation of the metallic wires.

13. An electrochromic device comprising two redox layers, wherein one of the redox layers contains metallic nanowires and the second redox layer does not contain metallic nanowires, and further the redox layer with the metallic nanowires colors cathodically.

14. The electrochromic device of claim 13, wherein the electrochromic device is configured such that it bleaches at a potential which is reverse in polarity to the coloring potential and is less than 0.5V.

15. The electrochromic device of claim 13, wherein the second redox layer comprises conductive particles of carbon salt.

16. The electrochromic device of claim 15, wherein cations of the carbon salt are selected from organic ions and alkali metal ions.

17. The electrochromic device of claim 13, wherein an agent is added to the layer containing metallic nanowires in an amount effective to prevent oxidation of the metallic nanowires.

18. An electrochromic device comprising two redox layers wherein both redox layers contain metallic nanowires and the composition of the nanowires in the two layers is different.

19. The electrochromic device of claim 18, wherein at least one of the layers further contains carbon nanoparticles.

20. The electrochromic device of claim 18, wherein the carbon nanoparticles are carbon salts.

21. The electrochromic device of claim 18, wherein the layers contain agents that prevent chemical or thermal oxidation of the metallic nanowires.

22. The electrochromic device of claim 20, wherein cations of the carbon salt are selected from organic ions and alkali metal ions.
